(19) United States
(12) Patent Application Publication
(10) Pub. No.: US 2026/0152922 A1
(43) Pub. Date: Jun. 4, 2026

(54) CONTROL SYSTEM AND METHOD OF OPERATION FOR A POWER SYSTEM FOR A MOBILE MACHINE

(71) Applicant: Caterpillar Inc., Peoria, IL (US)

(72) Inventors: Saravanan DURAIARASAN, Peoria, IL (US); Jacqueline D. KARL-DEFRAIN, Raleigh, NC (US); Kyle A. MATTHEWS, Metamora, IL (US)

(73) Assignee: Caterpillar Inc., Peoria, IL (US)

(21) Appl. No.: 18/965,220

(22) Filed: Dec. 2, 2024

(51) Int. Cl. E02F 9/20

(52) U.S. Cl. CPC E02F 9/2075; E02F 9/2079; E02F 9/2091

(57) ABSTRACT

A power system for a hybrid electric machine including: a power generation system including an engine, and a generator configured to generate electrical power based on power produced by the engine; a power converter in electrical connection with the power generation system and configured to command a load to the generator; a power distribution unit in electrical connection with the power generation system via the power converter; one or more batteries in electrical connection with the power distribution unit; and a controller configured to command the power converter to command a load from the power generation system, such that the power generation system produces power with a relatively higher voltage than the batteries. In another aspect, a software module includes an engine replacement library as a swappable block interfacing with a remainder of the software module, the engine replacement library including inputs specific to the engine.

### TECHNICAL FIELD

The present disclosure relates generally to a mobile machine, such as a wheel loader, and more particularly to a control system and method of operation for a power system for the mobile machine.

### BACKGROUND

Mobile machines may include various industrial vehicles that may move across the ground surface, and may include, for example, wheel loaders, excavators, trucks (e.g., dump trucks, haul trucks, articulated dump trucks, etc.), track-type tractors (i.e., bulldozers), graders, continuous miners, feeder breakers, roof bolters, utility vehicles for mining, load-haul-dump (LHD) vehicles, underground mining loaders, or underground articulated trucks. A mobile machine may be fully electric, semi-electric or hybrid electric (e.g., including a generator set that includes an engine producing mechanical power and a generator receiving the mechanical power and generating electrical power (often referred to as a “genset”), and one or more batteries storing the electrical power to power various systems and components of the machine, including the propulsion system that moves the machine across the ground surface), or non-electric (e.g., including a diesel or other combustion engine that powers the propulsion system). In a hybrid battery electric machine, a power distribution unit distributes electrical power generated by a secondary power source, e.g., the genset, to charge the one or more batteries. To charge the batteries, the secondary power source outputs power with a current within an acceptable range and with a voltage greater than the present battery voltage.

The methods and systems of the present disclosure may solve one or more of the problems in the art, including problems discussed below. The attached claims define the scope of the protection that the present disclosure provides, and the scope of protection is not dependent on the ability to solve any specific problem.

### SUMMARY

In one aspect, a power system for a hybrid electric machine includes: a power generation system including: an engine, and a generator configured to generate electrical power based on power produced by the engine; a power converter in electrical connection with the power generation system and configured to command a load to the generator; a power distribution unit in electrical connection with the power generation system via the power converter; one or more batteries in electrical connection with the power distribution unit; and a controller configured to command the power converter to command a load from the power generation system, such that the power generation system produces power with a relatively higher voltage than a voltage of the one or more batteries.

In another aspect, a hybrid electric machine includes: a machine body, including an engine compartment; a power generation system positioned within the engine compartment, wherein the power generation system includes: a power producer, and a generator configured to generate electrical power based on power produced by the power producer; a power converter positioned within the engine compartment, wherein the power converter is configured to command a load from the power generation system; a power distribution unit positioned within the engine compartment, wherein the power distribution unit is in electrical connection with the power generation system via the power converter; one or more batteries positioned within the engine compartment, wherein the one or more batteries are in electrical connection with the power distribution unit; and a controller configured to command the power converter to command a load from the power generation system, such that the power generation system produces power with a relatively higher voltage than a voltage of the one or more batteries.

In yet another aspect, a hybrid electric machine includes: a machine body; a power generation system positioned within or supported on the machine body, wherein the power generation system includes: an engine, a shaft, and a generator connected to the engine by the shaft, the generator configured to generate electrical power based on a mechanical output of the engine; a power converter positioned within or supported on the machine body, wherein the power converter is configured to receive electrical power from the generator; a power distribution unit positioned within or supported on the machine body, wherein the power distribution unit is configured to distribute power received from the power converter; one or more batteries positioned within or supported on the machine body, wherein the one or more batteries are configured to be charged with the power distributed by the power distribution unit; and a controller configured to command the power converter to command a load from the power generation system, such that the power generation system produces power with a relatively higher voltage than that of one or more batteries.

### BRIEF DESCRIPTION OF THE DRAWINGS

The accompanying drawings, which the Specification incorporated such that the figures constitute a part of the Specification, illustrate various exemplary embodiments and together with the description, serve to explain the principles of the disclosed embodiments.

FIG. 1 a schematic side view of an exemplary machine, according to aspects of the disclosure.

FIG. 2 is a schematic block diagram of an exemplary power system installed in the machine of FIG. 1, according to aspects of the disclosure.

FIG. 3 is a schematic block diagram of an exemplary engine replacement library for a software module of the power system of FIG. 2, according to some aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

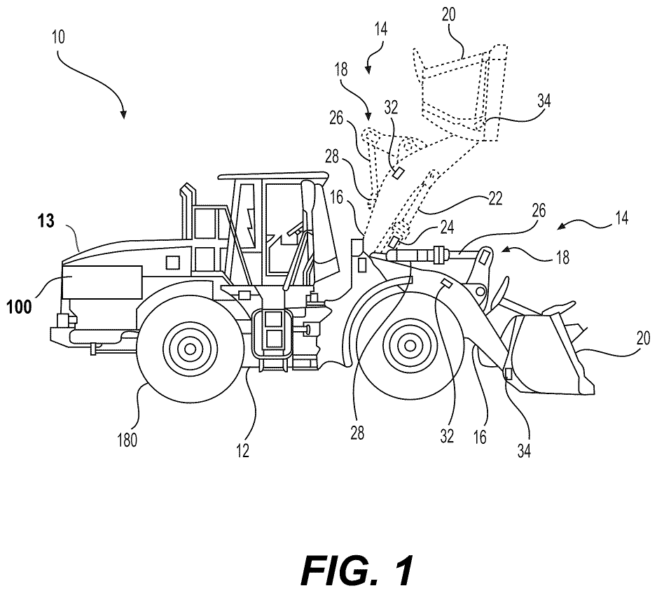

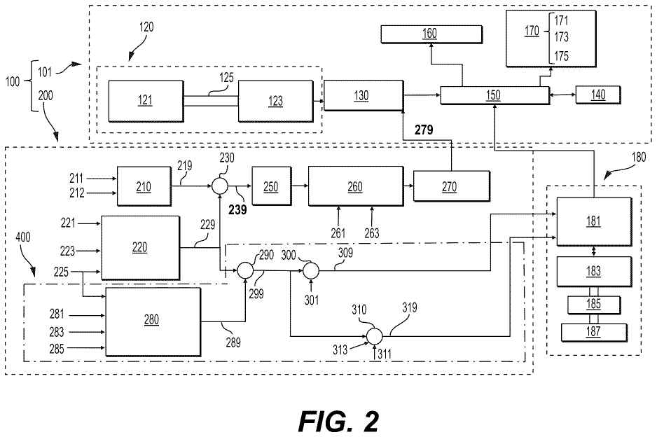

FIG. 1 is a schematic side view of an exemplary machine, such as a mobile machine, and more specifically a wheel loader 10, for example. As discussed below, the machine may be a hybrid electric machine (sometimes referred to as semi-electric or partially electric machine). Although FIG. 1 illustrates the mobile machine as a wheel loader, in aspects of the disclosure, the machine or mobile machine may be a machine other than a wheel loader, such as an excavator, truck (e.g., dump truck, haul truck, articulated dump truck, etc.), track-type tractor (i.e., bulldozer), grader, continuous miner, feeder breaker, roof bolter, utility vehicle for mining, load-haul-dump (LHD) vehicle, underground mining loader, or underground articulated truck, or another machine. With reference to FIG. 1, the wheel loader 10 may include a machine body 12. The wheel loader 10 may include an operator station (e.g., a cab), an engine compartment 13, and a power system 100 within the engine compartment 13 providing electrical power to a propulsion system 180 that may move the wheel loader 10 across a ground surface, as discussed in further detail below with reference to FIG. 2.

As FIG. 1 shows, the wheel loader 10 also may include an implement assembly 14. The implement assembly 14 may include an arm 16, a linkage 18, and an implement 20. The implement 20 may be coupled to an end of the arm 16. Although FIG. 1 shows the implement 20 as a bucket, in some aspects of the disclosure, the implement 20 may be a different work implement other than a bucket, such as a fork, a grapple, or another implement. In some aspects of the disclosure, the implement 20 may be interchangeable—e.g., removable and replaceable from the implement assembly 14. The linkage 18 may have one or more degrees of freedom. The propulsion system 180, discussed with reference to FIG. 2, may support machine body 12 and may receive power from the power generation system 120. Although FIG. 1 shows the propulsion system 180 including wheels, the propulsion system 180 alternatively may include tracks, for example. FIG. 1 also shows the wheel loader 10 in an exemplary first, lowered configuration (solid lines) of the implement assembly 14, and in an exemplary second, raised configuration (dashed lines) of the implement assembly 14.

A lift actuator 22 may power and control the movement (e.g., lift) of the implement 20 and/or the arm 16. The lift actuator 22 may include, for example, a hydraulic fluid cylinder actuator, or any other type of actuator. One or more lift pressure sensors 24 may measure forces within the lift actuator 22, or on another component of the lift actuator 22, and may be force sensors. A tilt actuator 26 may power and control the tilt of the implement 20. The tilt actuator 26 may include, for example, a hydraulic fluid cylinder actuator, or any other type of actuator. One or more tilt pressure sensors 28 may measure forces within the tilt actuator 26, or on another component of the tilt actuator 26, and may be force sensors. For example, as FIG. 1 shows, a head end and a rod end of the lift actuator 22 and the tilt actuator 26 may include the lift pressure sensors 24 and the tilt pressure sensors 28, respectively, therein or thereon. Alternatively or additionally, the lift pressure sensors 24 and the tilt pressure sensors 28 may be disposed in other locations relative to the lift actuator 22 and the tilt actuator 26, such as within a hydraulic circuit associated with an actuator. Forces acting on the lift actuator 22 or the tilt actuator 26 may include a head-end pressure and/or a rod-end pressure on each side of a piston of the actuator. The lift pressure sensors 24 and the tilt pressure sensors 28 may measure one or both of head-end and rod-end pressures of the lift and tilt cylinders, respectively. Alternatively, the lift pressure sensors 24 and the tilt pressure sensors 28 may measure a net force acting on a lift or tilt cylinder, respectively. The lift pressure sensors 24 and the tilt pressure sensors 28 may detect pressure of fluid within their respective actuator. Force or pressure information may also be derived from other sources, including other sensors. The wheel loader 10 may include one or more additional sensors, for example, an arm position sensor 32 and an implement position sensor 34. The arm position sensor 32 may gather data indicative of a position of the arm 16, including for example, an angle, a height or an extension of the arm 16. The implement position sensor 34 may gather data indicative of a position of the implement 20, including, for example, a height, lateral location, and/or tilt of the implement 20.

FIG. 2 is a schematic block diagram illustrating the power system 100 installed in the wheel loader 10. The power system 100 includes hardware 101 and a software module 200, with the software module 200 controlling operation of a power generation system 120 and the propulsion system 180. The software module 200 may include a controller programmed with software, and for convenience, this disclosure refers to the programmed controller as software module 200. The controller may be in communication with one or more features or portions of the wheel loader 10. The controller may receive inputs and send outputs, for example, in order to operate the wheel loader 10, including initiating one or more indications or warnings on a user interface, derating one or more components of the wheel loader 10, and/or stopping or shutting down one or more components of the wheel loader 10 or the entirety of the wheel loader 10. Although not shown, the controller may be coupled to or include one or more memory units, which may contain instructions for the controller to initiate one or more displays or one or more precautionary steps or procedures. The controller may be a separate controller on the wheel loader 10, or may be integrated into a central vehicle controller (e.g., a main power or operation controller, etc.). Alternatively, the controller may be integrated into one or more systems or modules on the wheel loader 10. In one aspect, the controller may control one or more electrical switches or valves in order to control one or more hydraulic cylinders or electrical elements in order to operate the wheel loader 10.

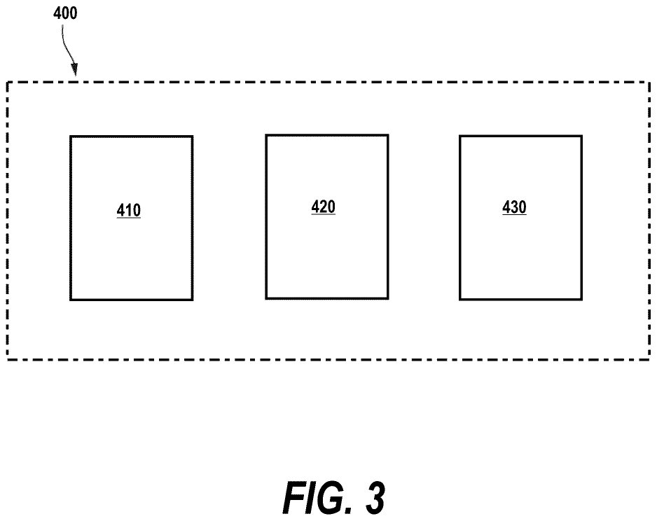

The controller may embody a single microprocessor or multiple microprocessors that may include systems for performing any of the operations mentioned herein. For example, the controller may include a memory (as stated above), a secondary storage device, a processor, such as a central processing unit, or any other systems for accomplishing a task consistent with the present disclosure. The memory or secondary storage device associated with the controller may be non-transitory computer-readable media that stores data and/or software routines that may assist the controller in performing its functions, such as the functions of method or process discussed below with reference to FIGS. 2 and 3. Further, the memory or secondary storage device associated with the controller may also store data received from the various inputs or sensors associated with the wheel loader 10. Numerous commercially available microprocessors can be configured to perform the functions of the controller. It should be appreciated that the controller could readily embody a general machine controller capable of controlling numerous other machine functions. Various other known circuits may be associated with the controller, including signal-conditioning circuitry, communication circuitry, hydraulic or other actuation circuitry, and other appropriate circuitry. As discussed herein, the controller may receive various inputs (e.g., from various sensors), and based on the various inputs, the controller may signal initiation of one or more indications or warnings (e.g., on a user interface) and/or one or more precautionary steps or procedure.

As FIG. 2 shows, the hardware 101 may include, among other components described below, a power generation package that may include the power generation system 120 and a power converter 130. The hardware 101 may also include a battery 140. Each of the power generation system 120, the power converter 130, and the batter 140 may be connected to a power distribution unit (PDU) 150. Although the description refers to the battery 140, in some aspects of the disclosure, the hardware may include multiple batteries (e.g., multiple battery packs or strings). The software module 200 may command the power generation package that includes the power generation system 120 and the power converter 130 to supply power to the power system 100, for example, to charge the battery 140. The power generation package does this, in some cases, by commanding to maintain a voltage above a present battery voltage and limit the current outflow to be a predetermined value or range, which stays within acceptable limits of the battery 140, and which is based on the state of operation of the machine, reported limits of the battery 140, and other factors. The voltage of the battery 140 and the power distribution unit 150 varies based on a state of charge (SOC) of the battery 140. The power converter 130 may convert three phase power (e.g., alternating current or AC power) produced by the power generation system 120, to two phase or single phase power (e.g., direct current or DC power) to match the battery 140 and the power distribution unit 150. The power generation package (e.g., the power generation system 120 and the power converter 130) may also convert any other power producer producing higher or lower voltage DC power to match the battery 140 and power distribution unit 150 voltage. While the voltage of the battery 140 increases during charging, the power converter 130 may continuously convert the power produced by the power generation system 120 to output substantially higher voltage that the voltage of the battery 140, and modulated by current flow to the battery 140. As a result, the power converter 130 may effectively charge the battery 140.

The power generation system 120 may include a generator-set or genset, and may have an engine 121, a generator 123, and a shaft 125 connecting the engine 121 and the generator 123. In some aspects of the disclosure, the power generation system 120 may be installed in the engine compartment 13 of the machine, such as in place of and after removal of a standard diesel engine or other combustion engine from the engine compartment 13, during conversion of a non-electric machine to a semi-electric or hybrid electric machine. In some aspects of the disclosure, the engine 121 may be a natural gas engine, a gasoline engine, a diesel engine, a propane engine, or another power producer such as a non-combustion power producer, for example, a fuel cell. Operation of the engine 121 may result in rotation of the generator 123, such that the generator 123 generates or produces electrical power having a voltage and a direct current, based on the output of the engine 121. In some aspects of the disclosure, the engine 121 may rotate at approximately 2800 RPM, although the engine 121 may run at a greater or a lesser number of revolutions per minute. In some aspects of the disclosure, the generator 123 may generate power having a relatively high voltage, such as for example more than about 750 V or about 1000 V. The power generation system 120 may output power to the power converter 130. The power converter 130 may provide power to the power distribution unit 150. The power distribution unit 150 may distribute power to one or more various systems and components connected to the power distribution unit 150, including the battery 140 and other components, as further described. The power converter 130 also may command a load from the power generation system 120, as further described below.

The power distribution unit 150 may receive power from the power converter 130, such that the power distribution unit 150 may distribute or output power to charge the battery 140, as well as distribute power from the battery 140, as further described. As FIG. 2 shows, the power distribution unit 150 may distribute power to a DC-to-DC converter 160, which may power components of the machine with power having a voltage different than the voltage of the power distributed by the power distribution unit 150. For example, the DC-to-DC converter 160 may power components with a relatively lower voltage (e.g., low voltage components) than the power distributed by the power distribution unit 150. In some aspects of the disclosure, examples of components powered by the DC-to-DC converter 160 include components within the engine compartment 13 or cab of the mobile the wheel loader 10, such as one or more of control valves, an evaporator, a pump, a chiller, a 24 V battery, a 12 Volt battery, a display, etc. The power distribution unit 150 also may distribute power to one or more high-voltage auxiliary loads 170. For example, the high-voltage auxiliary loads 170 may include one or more of an electric compressor 171, an electric fan 173, for example, within the engine compartment 13 of the wheel loader 10, or a cab compressor 175 within the cab of the wheel loader 10. In some instances, the power system 100 may receive low voltage power through an electrical vehicle supply equipment (EVSE).

The power distribution unit 150 may distribute power to the propulsion system 180 of the wheel loader 10, which may propel the wheel loader 10 across the ground surface. The propulsion system 180 may include an inverter 181. The inverter 181 may convert the power received from the power distribution unit 150 from power having a direct current to power having an alternating current. The inverter 181 may output the power with the alternating current to an alternating current (AC) motor and generator 183. The AC motor and generator 183 may connect to a gearbox adapter 185. The gearbox adapter 185 may connect to a transmission 187. The transmission 187 may connect to wheels of the wheel loader 10, to propel the wheel loader 10 over the ground surface. As the disclosure states above, in other aspects, the propulsion system 180 may include tracks, for example, in place of wheels. Accordingly, power provided by the power generation system 120 or the battery 140 may power the propulsion system 180 of the wheel loader 10.

The software module 200 may control operation of the above-described hardware 101, including the power generation system 120 and the power converter 130. For example, the software module 200 may control the power converter 130 to output voltage substantially higher than the battery 140 direct current voltage, and limit current to acceptable limits, as discussed below. In these aspects, the power output by the power converter 130 may be sufficient to charge the battery 140. The software module 200 may include a calculation module 210. The calculation module 210 may receive an input 211 indicating a target state of charge (SOC) of the battery 140. The input 211 may be a static value, and, in some aspects, a user or a programmer may input the value. The calculation module 210 also may receive an input 212 that is an actual state of charge (SOC) of the battery 140. The calculation module 210 may receive the input 212 from a sensor (not shown) that receives, for example, a current value, and the state of charge of the battery 140 is calculated based on the current value. The calculation module 210 may determine a difference between the input 211 and the input 212, and may provide an output 219 that indicates a power request of the battery 140. In some aspects of the disclosure, the calculation module 210 may be a proportional-integral (PI) controller.

The software module 200 may include a calculation module 220. The calculation module 220 may receive an input 221 indicating the direct current of the battery 140. The calculation module 220 may receive an input 223 indicating the direct current of the power generation system 120. The calculation module 220 may receive an input 225 indicating the voltage of the power distribution unit 150. The calculation module 220 may calculate a total power load, including that of the power generation system 120 and the battery 140. The calculation module 220 may provide an output 229 that indicates a total power load of the wheel loader 10.

The software module 200 may include a node 230 that may receive as inputs each of the output 219 and the output 229, and may provide an output 239 based on the output 219 and the output 229. The output 239 may indicate the power available to charge the battery 140 and support machine propulsion loads. The software module 200 may include a power rate limit 250 based on a power rate limit of the power generation system 120, and a power limit 260 based on a power limit of the power generation system 120. The power limit 260 may include a maximum power limit 261 and a minimum power limit 263 of the power generation system 120. Each of the power limit 260, the maximum power limit 261, and the minimum power limit 263 may be static values, and, in some aspects, a user or programmer may input or change the values.

The software module 200 may include a calculation module 270. Based on the output 239 from the node 230, the power rate limit 250, and the power limit 260, the calculation module 270 may determine a permissible range of power that the power generation system 120 may output. Based on the output 239 from the node 230, the power rate limit 250, and the power limit 260, the calculation module 270 also may determine a predetermined power level for that the power generation system 120 to output, which is within the permissible range and which is greater than the voltage of the power distribution unit 150 and the battery 140. The calculation module 270 may output a command 279 to the power converter 130, based on the predetermined power level, such that the power converter 130 may command an appropriate load from the power generation system 120. The commanded load may be sufficient to cause the power generation system 120 to produce power with a voltage higher than that of the power distribution unit 150. The power converter 130 may convert the power received from the power generation system 120 to power having a substantially higher voltage than that of the power distribution unit 150 and the battery 140, but limiting current based on the amount consumed by the system and the amount of current to charge the battery 140 to the targeted state of charge (SOC). Accordingly, the software module 200 may operate the power converter 130 and the power generation system 120 to provide power with a voltage and current sufficient to charge the battery 140 connected to the power distribution unit 150.

The software module 200 may control operation of the propulsion system 180. The software module 200 may include a calculation module 280. The calculation module 280 may receive the input 225. The calculation module 280 also may receive an input 281 based on an actual current of the AC motor and generator 183. The calculation module 280 may receive an input 283 based on an actual current of the DC-to-DC converter 160. The calculation module 280 may receive an input 285 based on an actual current of the high-voltage auxiliary loads 170. The calculation module 280 may provide an output 289 based on the input 225, the input 281, the input 283, and the input 285. The output 289 may be representative of all parasitic loads in the power system 100.

The software module 200 may include a node 290. The node 290 may receive as inputs the output 229 from the calculation module 220 and the output 289 from the calculation module 280. The output 229 from the calculation module 280 may represent the total power load in the power system 100. As mentioned above, the output 289 from the calculation module 280 may represent all the parasitic loads in the power system 100. The node 290 may provide an output 299 that is representative of the available power for operation of the propulsion system 180—e.g., the total power load minus the parasitic loads.

The software module 200 may include a node 300. The node 300 may receive an input 301 based on a maximum charge capability of the battery 140, and may receive the output 299 from the node 290, representing all of the parasitic power consumed for operation of the propulsion system 180, as well as low voltage and high voltage auxiliary systems. The node 300 may provide an output 309 to the inverter 181 of the propulsion system 180. The output 309 may be a motor DC retarding power limit determining a lower limit for operation of the AC motor and generator 183 by the inverter 181, which makes power available for charging of the battery 140.

The software module 200 may include a node 310. The node 310 may receive the output 299 from the node 290. The node 310 may receive an input 311 based on a maximum discharge capability of the battery 140. The node 310 may receive an input 313 based on a maximum power limit of the power generation system 120. The node 310 may provide an output 319 to the inverter 181. The output 319 may be a motor DC propulsive power limit determining an upper limit for operation of the AC motor and generator 183 by the inverter 181, to provide propulsive power to the propulsion system 180.

As discussed above, the engine 121 may be one (or more) of a variety of different power generation systems—e.g., the engine 121 may be a natural gas engine, a gasoline engine, a diesel engine, a propane engine, or another power producer. Various attributes of and inputs into the software module 200 may correspond to the specific power producer that is the engine 121. Thus, as FIG. 2 shows, the software module 200 may include an engine replacement library 400. The engine replacement library 400 includes inputs and attributes corresponding to the particular power producer—for example, whether the engine 121 is a natural gas engine, a gasoline engine, a diesel engine, or another power producer, the values of 261 and 263 as provided to the power limit 260 may differ, as the maximum and minimum power limits of the secondary power sources (e.g., the engine 121) may differ.

The above-described calculations contained in software module 200 may vary slightly with different secondary power sources (e.g., the engine 121) but are intended to operate in a similar fashion and provide the same machine level performance. Thus, in accordance with the disclosure, the engine replacement library 400 may be a swappable block that interfaces with a remainder of the software module 200 to minimize cost of development and communize retrofitted machine performance across various configurations. In these aspects, the swappable block is common to the software module 200 regardless of the machine into which the power system 100 is integrated, or regardless of the type or size of the engine 121. Restated, the engine replacement library 400 may include only those inputs and attributes that are not common to but are specific to particular types of engines or power sources. Thus, regardless of what type of power producer the engine 121 is, the software module 200 may include the same inputs, components, and modules other than those in the engine replacement library 400. Then, depending on what type of power producer the engine 121 is, the appropriate engine replacement library 400 may be integrated into the software module 200.

FIG. 3 is a schematic block diagram of the engine replacement library 400, according to some aspects of the disclosure. As FIG. 3 illustrates, the engine replacement library 400 may include one or more engine specific inputs 410 as inputs into an engine specific calculation module 420, and the engine specific calculation module 420 providing one or more engine specific outputs 430. The engine specific outputs 430 of the engine replacement library 400 may be outputs specific to the specific engine 121, generator 123, or power generation system 120. The engine replacement library 400 may be swapped in and out of the software module 200 as appropriate. The engine replacement library 400 may provide the engine specific outputs 430 to the common portion of the software module 200, as discussed above.

### INDUSTRIAL APPLICABILITY

The aspects of the power system 100 including the hardware 101 and the software module 200 of the present disclosure may apply to any semi-electric or hybrid machine, mobile machine, or industrial vehicle, such as the wheel loader 10 or other vehicle. As discussed, the hybrid machine in the form of the wheel loader 10 may include the power generation system 120, such as a generator set or gen-set having the engine 121 as well as the generator 123 that generates electrical power from the mechanical power produced by the engine 121. The hybrid machine in the form of the wheel loader 10 may charge the one or more batteries 140, which power the various systems and components of the wheel loader 10, including the propulsion system 180 that moves the wheel loader 10 over the ground surface. To help effectively charge the batteries 140, the disclosed power system 100 may provide power with a voltage substantially higher than the voltage of the batteries 140, modulated by limiting current to acceptable limits.

The disclosed power system 100 may provide power with the described voltage and current by commanding a load on the power generation system 120, such that the power generation system 120 provides power with a relatively higher voltage than that of the batteries 140. The power converter 130 may convert the three phase power to a single phase voltage. Further, as the voltage (e.g., the state of charge) of the batteries 140 changes, the voltage of the power provided by the power converter 130 may be increased above the voltage of the batteries 140 with a limited current output, such that the disclosed power system 100 effectively charges the batteries 140. Thus, the disclosed power system 100 provides numerous advantages, including the disclosed effective and efficient charging of the batteries 140, longer battery life, reduced engine operating time, reduced pollution, reduced repair and maintenance costs, etc.

The disclosed power system 100 also includes the software module 200 with the engine replacement library 400 in the form of a swappable block, which includes various inputs and attributes specific to the engine 121—for example, whether the engine 121 is a natural gas engine, gasoline engine, propane engine, or diesel engine. The swappable block includes all of the attributes that are specific to the particular engine or machine, and interfaces with the remaining portion of the software module 200 and the remaining portion of the electrified system. Thus, regardless of which type or size of power producer the power system 100 includes, customization of the software module 200 may be accomplished easily by integrating the specific swappable block into the common remainder of the software module 200. The use of a swappable block may help to reduce the time or costs associated with customizing the software module for the particular engine.

It will be apparent to those skilled in the art that various modifications and variations may be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A power system for a hybrid electric machine, comprising:
a power generation system including:
an engine, and
a generator configured to generate electrical power based on power produced by the engine;
a power converter in electrical connection with the power generation system and configured to command a load to the generator;
a power distribution unit in electrical connection with the power generation system via the power converter;
one or more batteries in electrical connection with the power distribution unit; and
a controller configured to command the power converter to command a load from the power generation system, such that the power generation system produces power with a relatively higher voltage than a voltage of the one or more batteries.

2. The power system of claim 1, wherein the power converter is configured to convert power generated by the generator from power having a first three phase voltage to power having a different, second single phase voltage, and
wherein the power distribution unit is configured to receive power having the second voltage, and to distribute power having the second voltage to the one or more batteries.

3. The power system of claim 1, wherein the power converter is configured to convert power generated by the generator from power having a first three phase voltage to power having a second single phase voltage and a predetermined current, wherein the second voltage is set higher than the voltage of the one or more batteries, and
wherein the power distribution unit is configured to receive power having the second voltage, and to distribute power having the second voltage to the one or more batteries.

4. The power system of claim 1, wherein the power distribution unit is configured to distribute power to one or more auxiliary loads.

5. The power system of claim 1, wherein the power converter is configured to convert the power generated by the generator to power having both i) a substantially higher voltage than a voltage of the one or more batteries, and ii) a predetermined current based on an allowable battery current limit.

6. The power system of claim 1, wherein the generator is configured to generate three phase, alternating current power based on mechanical power produced by the engine.

7. The power system of claim 1, wherein the engine comprises at least one of a diesel engine, a natural gas engine, a gasoline engine, or a propane engine.

8. The power system of claim 1, wherein the engine comprises a non-combustion power producer.

9. The power system of claim 1, wherein the power distribution unit is configured to distribute power to a propulsion system of the hybrid electric machine.

10. A hybrid electric machine comprising:
a machine body, including an engine compartment;
a power generation system positioned within the engine compartment, wherein the power generation system includes:
a power producer, and
a generator configured to generate electrical power based on power produced by the power producer;
a power converter positioned within the engine compartment, wherein the power converter is configured to command a load from the power generation system;
a power distribution unit positioned within the engine compartment, wherein the power distribution unit is in electrical connection with the power generation system via the power converter;
one or more batteries positioned within the engine compartment, wherein the one or more batteries are in electrical connection with the power distribution unit; and
a controller configured to command the power converter to command a load from the power generation system, such that the power generation system produces power with a relatively higher voltage than a voltage of the one or more batteries.

11. The hybrid electric machine of claim 10, wherein the power converter is configured to convert power generated by the generator from power having a first voltage to power having a second voltage.

12. The hybrid electric machine of claim 10, further comprising a DC-to-DC converter in electrical connection with the power distribution unit,
wherein the DC-to-DC converter is configured to convert power received from the power distribution unit to power having a lower voltage.

13. The hybrid electric machine of claim 10, further comprising:
one or more auxiliary loads in electrical connection with the power distribution unit, wherein the one or more auxiliary loads comprise at least one of a compressor or a fan.

14. The hybrid electric machine of claim 10, wherein the power converter is configured to convert the power to power having substantially higher voltage than a voltage of the one or more batteries.

15. The hybrid electric machine of claim 10, wherein the power converter is configured to convert the power to power having both i) a substantially higher voltage than a voltage of the one or more batteries, and ii) a predetermined current based on an allowable battery current limit.

16. The hybrid electric machine of claim 10, wherein the power producer comprises at least one of a diesel engine, a natural gas engine, a gasoline engine, a propane engine, or a non-combustion power producer.

17. The hybrid electric machine of claim 10, further comprising:
a propulsion system in electrical connection with the power distribution unit and configured to move the machine body over a ground surface.

18. A hybrid electric machine comprising:
a machine body;
a power generation system positioned within or supported on the machine body, wherein the power generation system includes:
an engine,
a shaft, and
a generator connected to the engine by the shaft, the generator configured to generate electrical power based on a mechanical output of the engine;
a power converter positioned within or supported on the machine body, wherein the power converter is configured to receive electrical power from the generator;
a power distribution unit positioned within or supported on the machine body, wherein the power distribution unit is configured to distribute power received from the power converter;
one or more batteries positioned within or supported on the machine body, wherein the one or more batteries are configured to be charged with the power distributed by the power distribution unit; and
a controller configured to command the power converter to command a load from the power generation system, such that the power generation system produces power with a relatively higher voltage than that of one or more batteries.

19. The hybrid electric machine of claim 18, further comprising:
a propulsion system including at least one of wheels or tracks,
wherein the power distribution unit is configured to distribute power to the propulsion system to operate the wheels or tracks.

20. The hybrid electric machine of claim 18, wherein the power converter is configured to convert the power to power having both i) a substantially higher voltage than a voltage of the one or more batteries, and ii) a predetermined current based on an allowable battery current limit.
